(19) United States
(12) Patent Application Publication
(10) Pub. No.: US 2006/0218380 A1
(43) Pub. Date: Sep. 28, 2006

(54) Add-shift-round instruction with dual-use source operand for DSP

(75) Inventors: Darrell D. Boggs, Aloha, OR (US); Chad E. Fogg, Hillsboro, OR (US); Christopher S. Jones, Portland, OR (US); Gary L. Brown, Aloha, OR (US)

Correspondence Address: Richard Calderwood;Stexar Corp., 20400 NW Amberwood Dr. #100, Beaverton, OR, 97006-7099, US

(73) Assignee: Stexar Corporation

(21) Appl. No.: 11/090,441

(22) Filed: Mar. 24, 2005

(51) Int. Cl. G06F 9/30

(52) U.S. Cl. 712/218

(57) ABSTRACT

A processor having an architecture including an instruction with a source operand from which the processor derives at least one of an operand value and a control value. The source operand may directly specify the operand value or the control value, with the other being implicitly specified. Or, both may be implicitly specified and derived from the source operand value. At least one of the operand value and the control value is implicit, not specified. An ADDSRN instruction which performs addition and right shifting and rounding, in which one of the source operands is an immediate which specifies the shift count N and the processor derives a third added 2^{N-1}, and the ADDSRN instruction is used in accelerating digital signal processing code sequences of the form
dest:=(A+B+C+D . . . +M+2^{N-1})>>N

### RELATED APPLICATIONS

This application is related to an application entitled “Instruction with Dual-Use Source Providing Both an Operand Value and a Control Value” and an application entitled “Rounding Correction for Add-Shift-Round Instruction with Dual-Use Source Operand for DSP”. These three applications have the same inventors, are commonly assigned, and are simultaneously filed.

### BACKGROUND OF THE INVENTION

1. Technical Field of the Invention

This invention relates generally to digital signal processors, and more specifically to an instruction for adding, right shifting an expressly specified distance, and rounding, in which a single operand provides the shift count and a rounding bias.

2. Background Art

FIG. 1 depicts an exemplary, conventional digital signal processor (DSP) or microprocessor (CPU), either of which may be termed a “processor”. The processor has an Instruction Set Architecture (ISA) such as those of the VelociTI, C55x, C54x, C62x, OMAP, etc. DSPs from Texas Instruments, the Z86 and Z89 DSPs from Zilog, or the CHAMP DSPs from Curtiss Wright Controls, or the X86 processors from Intel, the ARM processors from Advanced RISC Machines, or the MIPS processors from MIPS Technologies. DSPs typically use either a Reduced Instruction Set Computing (RISC) architecture or a Very Long Instruction Word (VLIW) architecture, and microprocessors typically use either a RISC architecture or a Complex Instruction Set Computing (CISC) architecture.

In addition to their ISA, some processors also have a microarchitecture which is not directly visible to the ISA code, and which is used at a lower level to implement the ISA. Many processors' microarchitectures are microcoded, in that they have their own “native” software format and control constructs.

In the example shown, the processor retrieves and executes this code from a memory/storage system under control of an instruction fetcher. To improve performance, the ISA code is typically stored in an instruction cache, and may be speculatively brought in from memory/storage by a prefetcher in coordination with a branch predictor. There may also be a separate data cache in some instances. Memory may include DRAM, SRAM, ROM, flash memory, or the like, and storage may include hard disk, CD-ROM, DVD-RAM, or the like. The memory and storage may be coupled directly to the processor, or it may be coupled indirectly via one or more intervening systems or transmission means (not shown). In some embodiments, it may reside on die with the processor core.

Regardless of how or when the code is brought into the processor, before it can be executed, an instruction decoder parses the incoming code to ascertain which instructions are contained in the code. In many machines, the instruction decoder generates microcode including a series of one or more microinstructions which correspond to a given ISA instruction. While the ISA code may be thought of as being the “native” instructions of the architecture, the microcode (μcode) is the “native” instructions of the microarchitecture or the execution units in the processor.

Some ISA instructions, such as trigonometric math functions, require complex operations, and result in lengthy microcode flows. In many instances, it is beneficial to permanently store these microcode flows in a microcode read-only memory (ROM). When the instruction decoder detects such an ISA instruction, the instruction decoder triggers the microcode ROM to output the corresponding microcode flow.

The microcode from the instruction decoder and/or from the microcode ROM is sent to a microinstruction scheduler which controls the delivery of the microcode instructions to the various execution units of the processor, in accordance with the availability of the execution units, the availability of the required input data operands for the microinstructions (pops), and so forth. Ultimately, the microinstructions are executed and their results are written to their appropriate destinations, whether in the register file, memory, storage, or the like. The results are typically also written to the data cache.

### ISA Instructions

All ISAs include various forms of add and subtract instructions. These typically specify two or more source operands such as registers, whose contents are added or subtracted to generate a result which is written to a destination. In some instructions, the destination is expressly identified as an operand of the instruction. In others, the destination is implicit, either in that the result is always written to the same register, or in that the result is written to the register from which one of the source operands was taken.

For example, the X86 instruction set includes an instruction of the form:
ADD(r1, imm)
   which performs the addition operation:
   r1 :=r1+imm
   in which the second operand is an immediate value which expressly specifies the second addend.

Most ISAs include various instructions which employ one or more rounding modes. When the execution unit produces a result whose precision is greater than the destination is able to represent, the result is rounded before being stored to the destination. A variety of rounding ii modes are known in the art, such as: round toward zero, round away from zero, round toward positive infinity, round toward negative infinity, and round to nearest. There are two common variations of round to nearest, differing in how they handle numbers which fall exactly between two valid rounding results (e.g. at X.5); in the “round to nearest even” mode, 2.5 is rounded to 2, and 3.5 is rounded to 4; in the “round to nearest up” mode, 2.5 is rounded to 3, and 3.5 is rounded to 4.

FIG. 2 illustrates the “round to nearest up” mode. The graph illustrates a function of the form:
y=f(x)
where, for each possible value of x, there is exactly one value y.

The rounding function operates as follows. The “open” function markers (shown as non-filled circles) do not constitute part of the function result line, but the “closed” function markers (shown as filled circles) do. For any value on the x axis, there is exactly one point where that x value intersects the function curve, specifying a resulting y value. The open and closed function markers fall at exactly the 0.5 midpoints between adjacent integers, such as at −2.5 and at 1.5. If the x value is exactly Z.5 (where Z is any integer), the resulting y value is Z+1. Thus, the rounding function is “round to nearest integer, and round 0.5 midpoints up.”

Most ISAs also include various forms of shift instructions, which cause the contents of a specified source operand register or an intermediate result to be bit-shifted either left or right as specified by the opcode of the instruction. The shifted result is then written to a specified register or an implicitly identified register. The number of bit positions by which the result is shifted, is typically specified as an immediate value or register operand in the instruction. For example, the X86 architecture includes an instruction of the form:
SAR(r1, imm)
   which performs the shifting operation:
   r1:=r1>>imm
   in which the second operand is an immediate value which expressly indicates the shift count.

There are a very few examples of implicitly specified shift count values. For example, the X86 architecture includes an instruction of the form:
PAVG(r1, r2)
   which performs an average-with-rounding operation:
   r1:=(r1+r2+1) >>1
   Note that the addend value 1 and the shift count value 1 are not expressly specified in the instruction; they are implicit, and their values are always 1.

FIG. 3 illustrates the “round to nearest even” mode.

FIG. 4 illustrates the round to zero mode, also known as the truncation mode.

FIG. 5 illustrates the round to positive infinity mode, sometimes referred to by the potentially misleading name “round up mode” (which is easily confused with “round to nearest up”). Not illustrated is the round to negative infinity mode, sometimes referred to by the potentially misleading name “round down mode” (which is easily mistaken to suggest truncation).

### DSP Algorithm Equations

Many digital signal processing software algorithms, such as multi-tap filters, perform operations which are implemented by series of multiple instructions, and which are of the equation form:
dest :=(a+b+c+d . . . +x+2ⁿ⁻¹)>>n
where dest is the destination, a through m are a set of two or more source operands, and >> is the right shift operation, where the sum of the various operands is right shifted by n bit positions.

These operations are typically executed hundreds of times for each macro-block in a video display, each time the frame is refreshed. Each of these operations requires the execution of a lengthy sequence of instructions.

What is needed, then, is an improved digital signal processor which includes one or more new instructions specifically designed to execute these digital signal processing software operations in a reduced number of instructions or clock cycles.

### BRIEF DESCRIPTION OF THE DRAWINGS

FIG. 1 shows a typical processor according to the prior art.

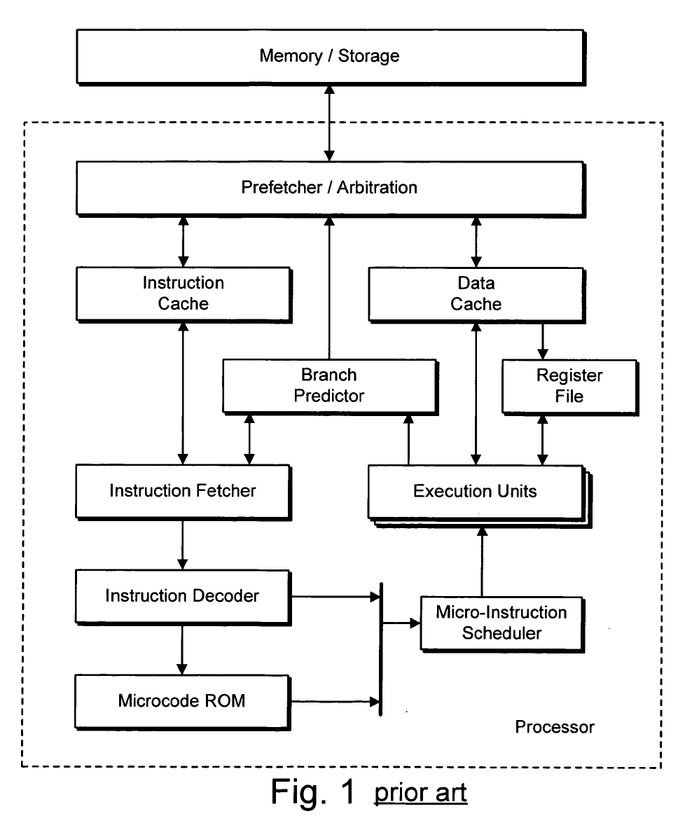

FIGS. 2-5 show function graphs of rounding functions according to the prior art.

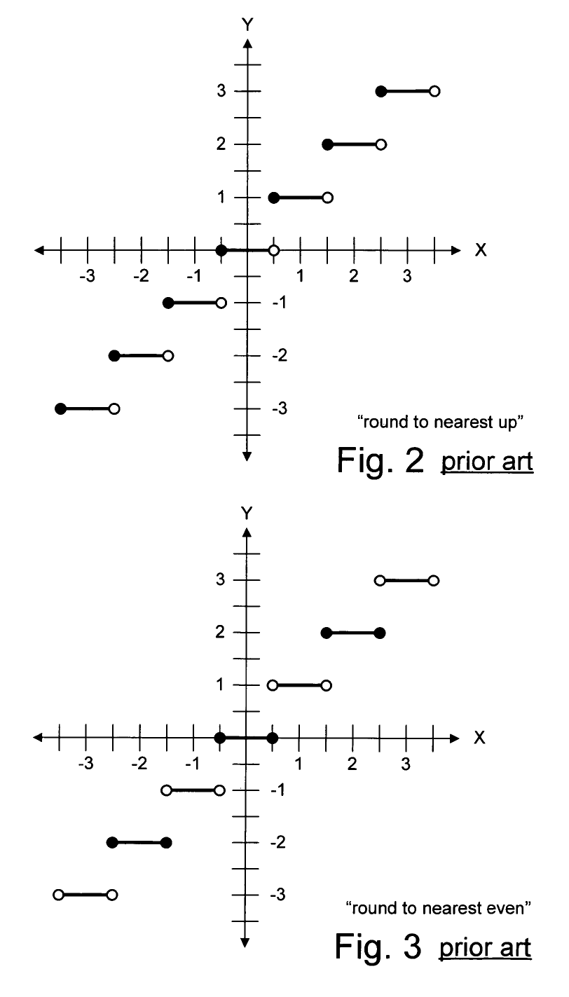

FIG. 6 shows a functional schematic diagram of a portion of a processor execution unit which executes an instruction according to one embodiment of this invention, in which a third operand of the dual-use-source instruction specifies a shift count N=3 and the processor derives from it a rounding bias operand value 2^{N-1}=4.

FIG. 7 shows a schematic of a different embodiment of a processor execution unit, for use in architectures in which the shift count N is not allowed to be zero in SRC3. The example shows the third operand of the dual-use-source instruction specifying a shift count N=4 and the processor deriving from it a rounding bias operand value 2^{N-1}=8.

FIG. 8 shows a functional schematic diagram according to another embodiment of this invention, in which the third operand of the dual-use-source instruction specifies the power N=3 of the rounding bias value which the processor derives as 2^{N}=8, and the processor also derives from it a shift count N+1=4.

FIG. 9 shows another embodiment in which the source value flows down unchanged to be used as an operand value.

FIG. 10 shows a functional schematic diagram according to another embodiment of the invention, which allows for an ADDSRN instruction, an ADDS instruction, and conventional shifting instructions.

FIG. 11 shows a functional schematic of an embodiment in which the rounding bias value and the shift control word value are identical.

FIG. 12 shows a processor according to one embodiment of this invention.

FIG. 13 shows a SIMD implementation in which the same rounding bias and shift count is used for all of the SIMD operations performed by a single SIMD instruction.

FIG. 14 shows a SIMD implementation in which each of the SIMD operations performed by a given SIMD instruction can have their own, individual rounding bias and shift count values.

FIG. 15 is a flowchart showing a method of executing an ADDSRN instruction according to one embodiment of this invention.

FIG. 16 is a flowchart showing a method of executing an instruction in which one of the sources provides a direct value and a decoded value, one of which is used to control operation of the execution unit, and the other is used as an operand.

FIG. 17 is a flowchart showing a method of executing an instruction in which both of the operand value and the control value are derived from the source value.

FIG. 18 is a flowchart showing one method of executing a dual-use-source instruction in a SIMD machine, in which the SIMD operations use the same dual-use source.

FIG. 19 is a flowchart showing another method of executing a dual-use-source instruction in a SIMD machine, in which each SIMD operation has its own dual-use source.

FIG. 20 is a functional schematic diagram of another embodiment of this invention, in which the rounding is applied as a correction after the fact rather than by adding a rounding bias.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

The term “source value” will be used to denote the original value of the operand in question, either the value of an immediate, or the contents of a register, or the contents of a memory address, and so forth. The term “operand value” will be used to denote the value upon which an instruction's functionality is performed, such as an addend, whether directly specified by the source value or derived from the source value. The term “control value” will be used to denote a value which controls some arithmetic etc. characteristic of the functionality of the instruction. For example, the instruction's opcode may specify that the instruction is a shift instruction, and a control value may determine whether the shift is left or right, and/or by how many bit positions the result is shifted, and so forth.

A processor using this invention executes a “dual-use-source instruction”, which is one in which a single source value results in both an operand value and a control value. The processor generates the operand value or the control value or both from the source value.

For ease of illustration, the invention will mainly be discussed with reference to embodiments in which the source value is specified as an immediate, but the invention is not necessarily limited to such embodiments.

The present invention includes provision in the processor for executing a new instruction, which may be represented as being of the form:
ADDSRN (dest, src1, src2, imm)
   and which performs the function:
   dest:=(src1+src2+2^{imm-1})>>imm
   in which “>>” denotes right shifting.

In this instance, ADDSRN operates on signed values. In some embodiments, there may also be an unsigned version ADDSRN.U of this instruction, but for purposes of illustrating the invention, they will collectively be referred to as simply ADDSRN in this disclosure. The mnemonic suggests “ADD and Shift Right and round to Nearest”.

This instruction is especially useful in speeding up the DSP operation
dest:=(a+b+c+d . . . +m+2ⁿ⁻¹)>>n
Specifically, the ADDSRN instruction performs the addition of the final three operands, the shifting, and the rounding, in a single instruction. In some embodiments, this may be accomplished in a single clock cycle.

This instruction represents a significant improvement over the prior art. In previous DSP systems, it was necessary to perform a complex and time-consuming series of instructions to perform the functionality of the single ADDSRN instruction. The following is a comparison of the present invention with a hypothetical prior art machine, in executing this operation:
R1:=(R2+R3+R4+R5+2¹)>>2

| Present Invention | Prior Art DSP |
|---|---|
| R6 := ADD(R2, R3, R4) | R1 := ADD(R2, R3, R4) |
| R1 := ADDSRN(R6, R5, 2) | R1 := ADD(R1, R5, 2) |
| | R1 := SHIFTRIGHT(R1, 2) |

Assuming that all are single-cycle instructions, and that execution must be serialized (only a single ALU), the prior art DSP takes 50% longer to complete the operation than does the present invention.

The following is a comparison on a more complex operation:

R1 := (R2 + R3 + R4 + R5 + R6 + R7 + R8 + R9 + 2³) >> 4

| Present Invention | Prior Art DSP |
|---|---|
| R1 := ADD(R2, R3, R4) | R1 := ADD(R2, R3, R4) |
| R10 := ADD(R5, R6, R7) | R10 := ADD(R5, R6, R7) |
| R10 := ADD(R8, R9, R10) | R10 := ADD(R8, R9, R10) |
| R1 := ADDSRN(R1, R10, 4) | R1 := ADD(R1, R10, 8) |
| | R1 := SHIFTRIGHT(R1, 4) |

Using those same assumptions, even on this longer flow, the prior art processor takes 25% longer to complete the operation than does the present invention.

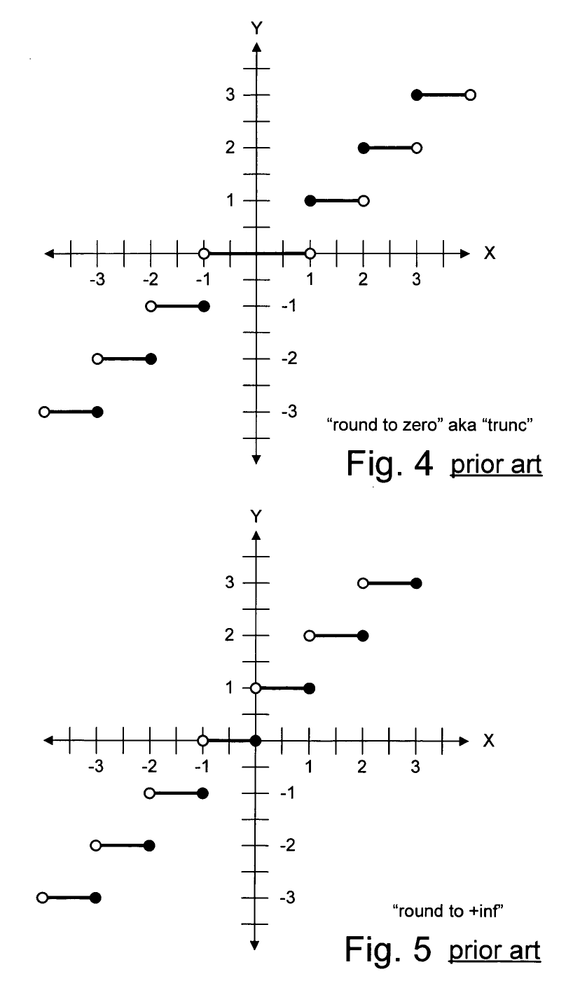

FIG. 6 illustrates a portion of a dual-use-source execution unit, typically an arithmetic logic unit (ALU), in a processor according to one embodiment of this invention. The ALU includes data pathways for receiving three source inputs, SRC1, SRC2, and SRC3, which can come from any of a variety of data locations, such as a register file, memory, storage, other ALUs, and so forth. Each source input specifies a source value. The operands are ultimately provided as inputs to an arithmetic functional unit such as an adder, which performs addition or subtraction operations on the source data to generate a result, which is written to a destination. The destination may be a register, a memory location, and so forth.

The first source value SRC1 and the second source value SRC2 are provided as operands to the adder, typically via a chain of logic (omitted here for simplicity) which may include a shifter, a bypass mux, and so forth.

The adder receives the third source value SRC3 via another logic chain. For clarity of explanation, an SRC3 value of 00000011₂ or 3₁₀ is illustrated. The third source value is provided to an immediate decoder (IMM DEC) which assumes that the third source value is an encoded value for use in executing the ADDSRN instruction. The immediate decoder decodes the source value N into the rounding bias value 2^{N-1} (DEC_SRC3). In the example shown, the immediate 00000011₂ is decoded into the value 00000100₂. The original third source value 00000011₂ and the decoded control value 00000100₂ are provided to a decode mux which selects one of them, according to a control signal is_ADDSRN which indicates whether the instruction is, in fact, the ADDSRN instruction. This same hardware can also be used to execute a three-input ADD instruction in which SRC3 explicity identifies the third addend.

A bypass mux receives the output of the decode mux, and also a variety of other data sources from which operand values can be taken, such as the outputs of other ALUs (not shown). A bypass mux control value SRC3_Select determines which of these inputs provides the third source value for the current instruction. In the case of the ADDSRN instruction, it will select the data coming from the decode mux.

Because this hardware may be capable of executing a variety of instruction types, not all of which have a third operand, a 3S mux selects either the output of the bypass mux, or the value 00000000₂ (zero, which is inert in addition and subtraction operations), to be used as the third input to the adder, according to a control signal is_{—}3S which indicates whether the current instruction has a third operand.

The adder then adds these three operand values, optionally (but advantageously) with one or two bits of extra internal precision (to handle intermediate overflows, sign extension, and rounding modes), and provides the resulting sum to a result shifter.

The result shifter shifts this sum by a number of bit positions determined by a shift count control value at a shift control input. In the case of the ADDSRN instruction, the shift count value is the decoded value of the SRC3 operand. A count mux selects either the value zero or the output of the bypass mux as the shift count, according to a control signal is_Shift which indicates whether the current instruction is an instruction in which the shift count will come from the bypass mux of the SRC3 logic chain. Recall that the shift count was specified as N (00000011₂) by the original instruction, but has been decoded into the form 2^{N-1} (00000100₂) by the immediate decoder. Typically, the result shifter will be constructed as a set of shift muxes, one per adder output bit line, and these muxes select among their inputs according to a set of mutually exclusive control inputs (in which exactly one bit will be 1 and the rest will be 0). In instructions which do not shift, or which shift by zero positions, the least significant bit (LSB) of the shift muxes' control inputs will be 1.

Note that the decoded SRC3 value will have at most one “1” bit (because the decoder generates a number of the form 2^{N-1}), and that it will be in the N^{th} position from the right (LSB) of the decoded SRC3 value. In one embodiment, the count mux appends to its output an extra bit in the least significant bit position, which is 1 when the is_Shift control signal selects the 0 input of the count mux, and 0 otherwise; this extra bit signal can be used to control the result shifter muxes to select their “pass through” (non-shifted) input—it becomes the LSB of the shift mux control word. In one embodiment, this LSB is generated simply by a NOR gate whose inputs are the various bits of the count mux output; when is_Shift is 0 (and the count mux passes through the constant 00000000), or when the output of the bypass mux is 00000000, the LSB NOR gate generates a 1; otherwise, it generates a 0.

The output of the result shifter is then written to the destination specified by the instruction.

Note that, in this embodiment, the original SRC3 shift control value 00000011₂ has been discarded early in the logic chain, and only its decoded data operand counterpart 00000100₂ is used in later stages of the logic chain. And note further that, in this embodiment, the special mathematical relationship between the binary representations of N and 2^{N-1} (specifically, that the binary 2^{N-1} has exactly one 1 and it falls in the Nth position from the right) enables this to be the case. If the operand value and the control value had some other mathematical relationship, such as N and 3N+7, or N and N/2+1, it might be necessary to pass both N and 2^{N-1} down parallel logic chains.

If the SRC3 input had been 00000101₂ or 5₁₀, the immediate decoder would have generated the value 00010000₂ or 16₁₀. The adder would add SRC1+SRC2+00010000₂ and the result would have been shifted by five positions.

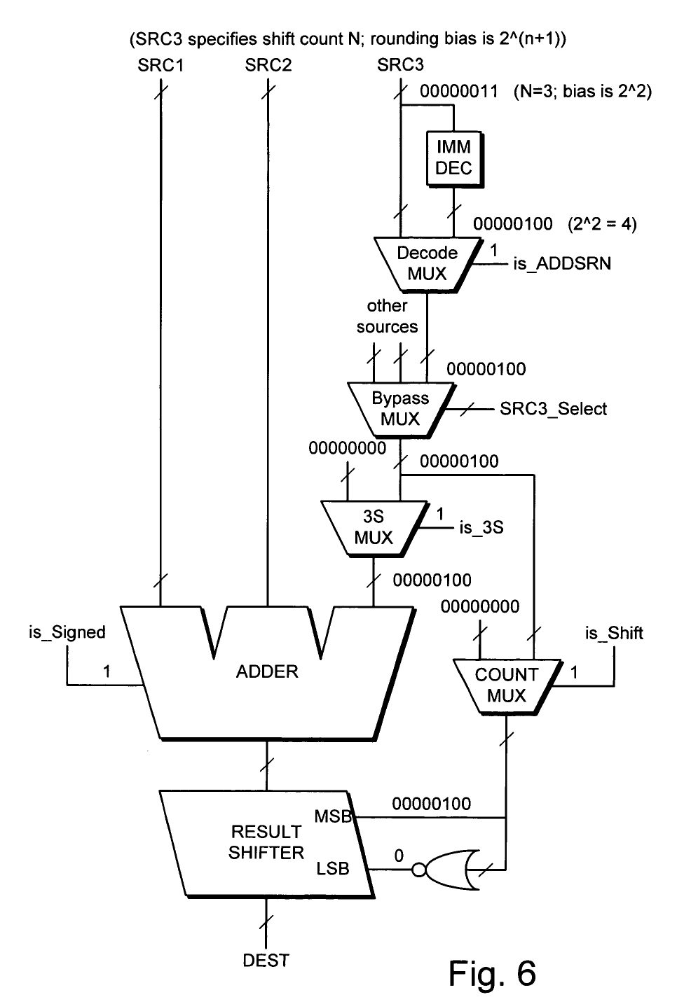

FIG. 7 illustrates a portion of a slightly modified execution unit, showing its operation with an SRC input value of 00000101₂ or 5₁₀. In this embodiment, the architecture does not allow the SRC3 source to specify a shift count of 0. The LSB of the result shifter control word is the inverted is_Shift signal. If is_Shift=0, meaning the instruction is not a shift instruction, the LSB will be 1, causing the shifter to shift the result by zero positions. Otherwise, the LSB will be 0, and some bit within the rest of the control word will be 1, determining the non-zero number of bit positions by which the result is shifted.

In this embodiment, the immediate decoder has been moved downstream of the bypass mux, making the circuit suitable for use with an ISA in which the dual-use operand is not necessarily an immediate value. By decoding the output of the bypass mux, the shift count can be taken from, e.g., the result of an immediately preceding instruction which has not even been written to the register file yet.

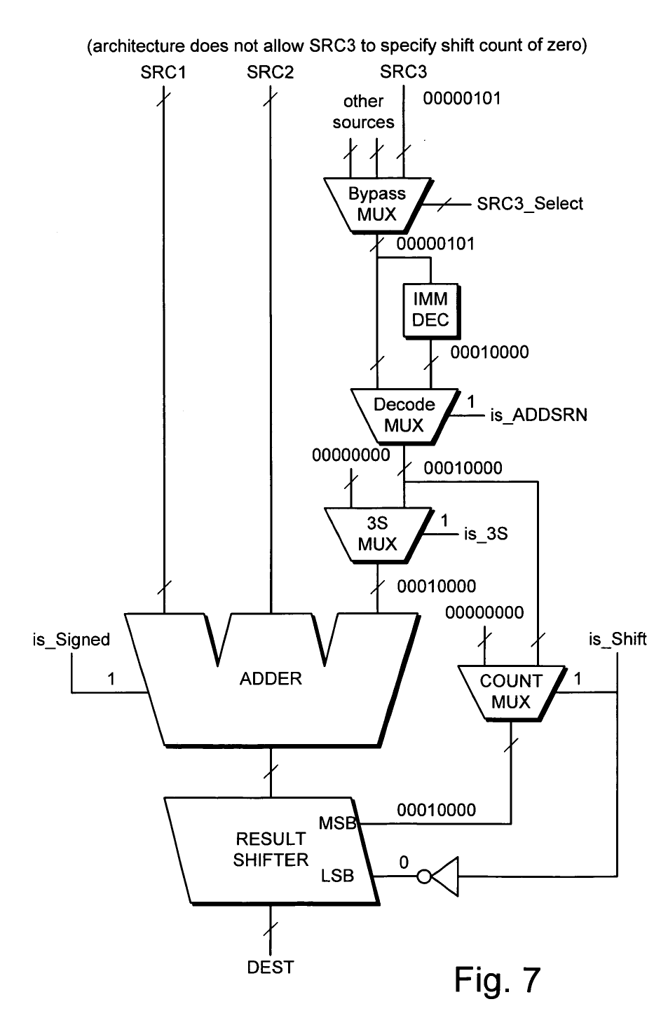

FIG. 8 illustrates another embodiment of the ALU circuitry, adapted for use with an architecture in which the SRC3 source does not directly specify either the operand value nor the control value which will ultimately be used by the ALU, and in which the processor derives both from the specified source value. In this instance, the dual-use-source SRC3 specifies the exponent N of the rounding bias implicit operand, and the processor derives the rounding bias value as 2^{N} and the shift control value as N+1. In the particular instance shown, SRC has a value of 00000011₂ or 3₁₀ from which the processor derives a rounding bias value 2³=8 and a shift control value 3+1=4.

The immediate decoder performs the function 2^{N} on the SRC3 operand value, generating the rounding bias value which will be passed down the logic chain to the third input of the adder. In the embodiment of FIG. 7, the count mux took its second input from the output of the bypass mux. However, in the embodiment of FIG. 8, the count mux takes its second input from the output of an adder (or incrementer INC) which performs the operation N+1 on the SRC3 operand value, generating the shift count value.

Note that in this embodiment, the original value of SRC3 did not directly specify either the bias value nor the shift count; both are derived from it by the processor. In the example shown, both are related to the SRC3 value by respective arithmetic functions. In other embodiments, one or both could be more indirectly derived from it. In other words, SRC3 may simply be a decode input value which is used as a mere index into respective decode lookup tables storing corresponding bias values and shift counts, neither of which may necessarily be mathematically related to the SRC3 value.

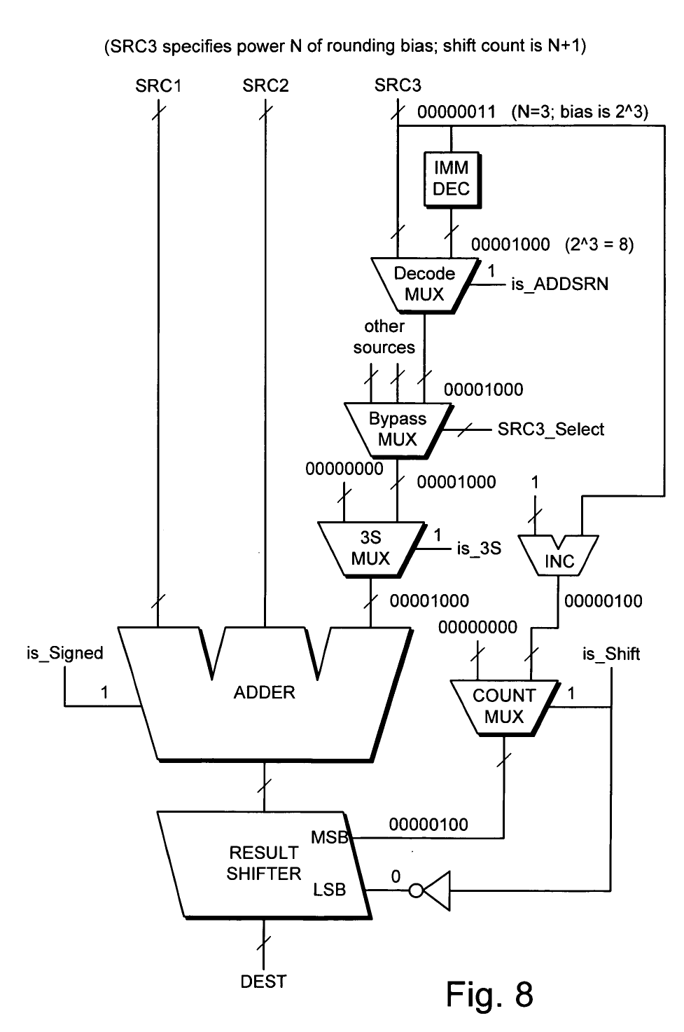

FIG. 9 illustrates a processor in which the source value is passed through, literally unchanged and undecoded, as the third operand value. The source value is shown as 00000111₂ or 7₁₀. SRC3 directly specifies the rounding bias value N, and the processor logic generates from it a shift control value (N−1)/2, which in this case is 3₁₀ which is encoded as 00000100₂ for use as the shift control value causing three bits of shifting. (Note that this is a different relationship between the shift control value and the rounding bias, than is illustrated in previous embodiments. It is not suitable for use in the DSP operation described above, and is shown here only to more directly demonstrate that the source value can directly specify the operand value.)

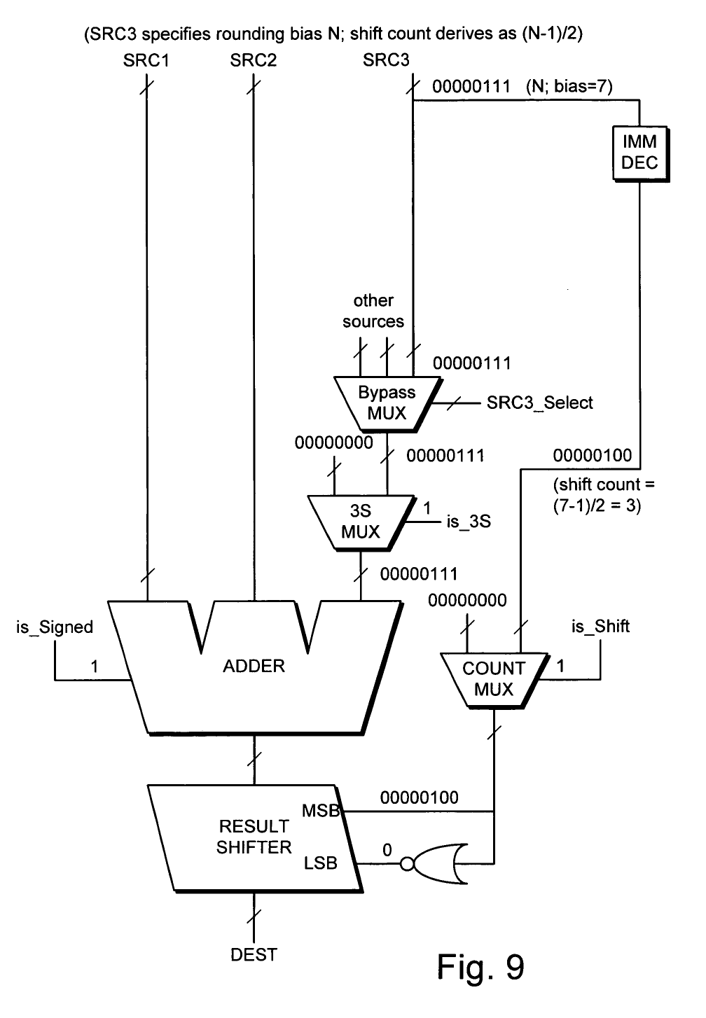

FIG. 10 illustrates an arithmetic logic unit according to another embodiment of this invention. In this embodiment, the ISA includes an ADDSRN (add, shift, round to nearest) instruction, an ADDS (add, shift) instruction, and other non-adding shift instructions. The logic for determining the adder's third addend input includes an immediate decoder, a decode mux controlled by an is_ADDSRN signal, and a bypass mux controlled by an SRC3_Select signal, as described above. Its 3S mux provides either a zero value or the output of the bypass mux as the third addend. The 3S mux is controlled by the output of an AND gate whose inputs are the is_{—}3S signal (which indicates whether there is a third operand in the instruction) and an inverted is_ADDS signal (which indicates whether the instruction is the ADDS instruction). If there is no third operand, the third addend should be zero (which is inert in add/sub operations). If the instruction is ADDS, the third operand specifies the shift count only, and there is no third addend (unlike the ADDSRN instruction, in which the rounding bias is the third addend), so the 3S mux will pass the zero to the adder.

The shift count is provided by a count mux which includes one-hot-output decoder logic on its control inputs, which operates as follows. If the is_ADDSRN signal is active, the count mux passes the output of the immediate decoder. Otherwise, if the is_ADDS signal is active, the count mux passes the SRC3 value. Otherwise, if the is_Shift signal is active, the count mux passes the SRC2 value. Otherwise, the count mux passes a zero value.

If the instruction is e.g. a SHIFT instruction which does not include addition, its operands will be a value to be shifted on SRC1, and a shift count on SRC2. In some embodiments, the is_Shift signal may be active for SHIFT, ADDS, and ADDSRN instructions. The count mux's one-hot decoder logic performs prioritization among the is_ADDSRN signal, the is_ADDS signal, and the is_Shift signal, to correctly generate the mux selection signals.

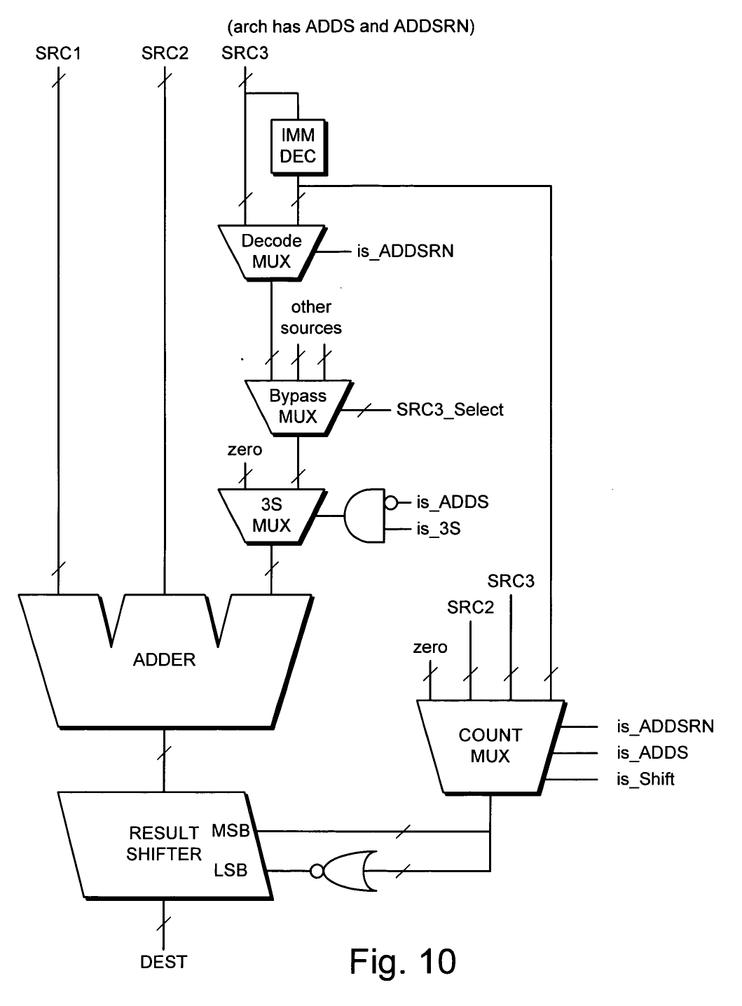

FIG. 11 illustrates an arithmetic logic unit for use in a processor in which the ADDSRN instruction uses a shift count and a rounding bias which have the same bit pattern. The SRC3 value is provided directly to the bypass mux and the count mux. When the instruction is ADDSRN, the SRC3_Select and is_{—}3S signals will pass the SRC3 value through to the adder's third input, and the count mux will pass the SRC3 value. If the instruction is a regular SHIFT, the is_Shift signal will cause the count mux to pass the SRC2 value. Otherwise, the count mux will pass a zero value. In this embodiment, it may be said that the SRC3 value specifies the rounding bias or the shift count, and that the other is derived from it by the identity function.

In another, similar embodiment, the shift count and rounding bias have identical bit patterns, but SRC3 does not directly, expressly specify the bit pattern. For example, the ISA may allow only a very limited set of shift counts and corresponding rounding bias values, and the instruction may include a limited bit field containing an encoded value which selects among the allowed shift counts. For example, a two-bit field could specify: 00 for a shift count and rounding bias of 00000010₂, 01 for a shift count and rounding bias of 00000100₂, 10 for a shift count and rounding bias of 00001000₂, and 11 for a shift count and rounding bias of 00010000₂. In this instance, the two-bit field may not necessarily arrive on the SRC3 lines, and there will be a decoder (not shown) which generates the appropriate shift count/rounding bias value, and mux logic (not shown) feeding the generated value into the bypass mux and the count mux.

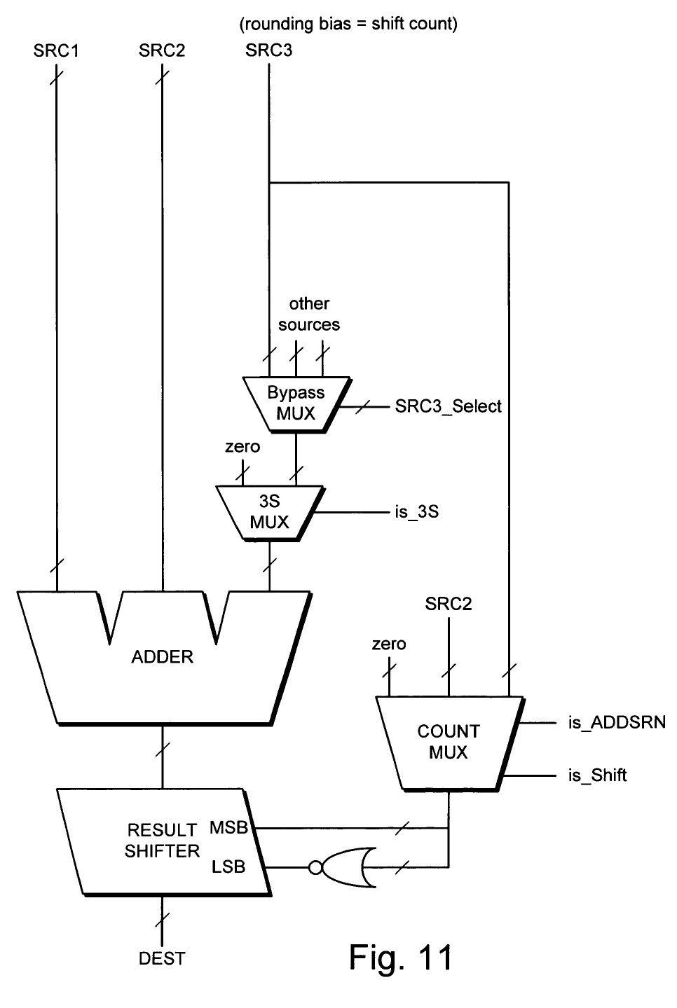

FIG. 12 illustrates a processor according to one embodiment of this invention. The prefetcher, caches, instruction fetcher, register file, branch predictor, and other execution units may be substantially as known in the prior art. The invention can be used in machines that are microcoded, or in machines that are microcoded.

The instruction decoder (or an instruction scheduler or other suitable microarchitectural component) provides the is_ADDSRN, SRC3_Select, is_{—}3S, is_Signed, and is_Shift control signals to the dual-use-source arithmetic logic unit, which may be substantially as shown in FIG. 6.

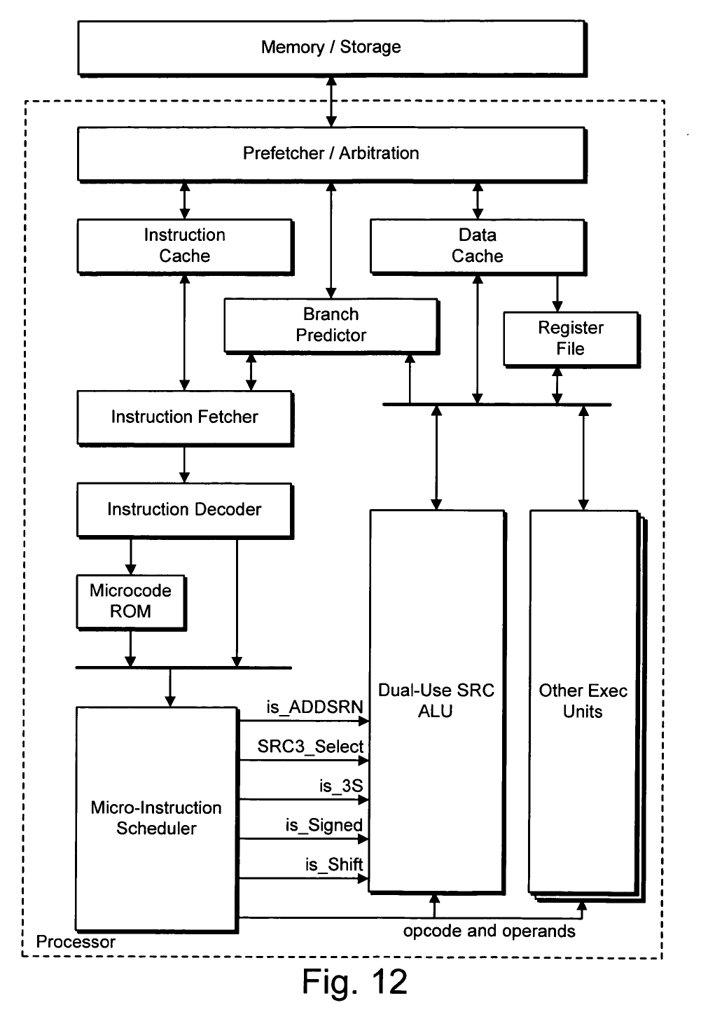

FIG. 13 illustrates a SIMD processor implementation of the dual-use-source instruction. A SIMD instruction (not shown) specifies one or more SIMD data sources such as registers (SIMD_R1 and SIMD_R2) and a SIMD result destination (SIMD_R3). In this embodiment, the SIMD instruction specifies a single dual-use-source (such as an immediate) from which the same rounding bias value and the same shift count are provided to all of the SIMD ALUs. In the example shown, the instruction's immediate field directly specifies the shift control word, which is fed in parallel to all four of the result shifters, and a single immediate decoder derives from the shift control word a rounding bias value, which is fed in parallel to the third operand input of each ALU's adder.

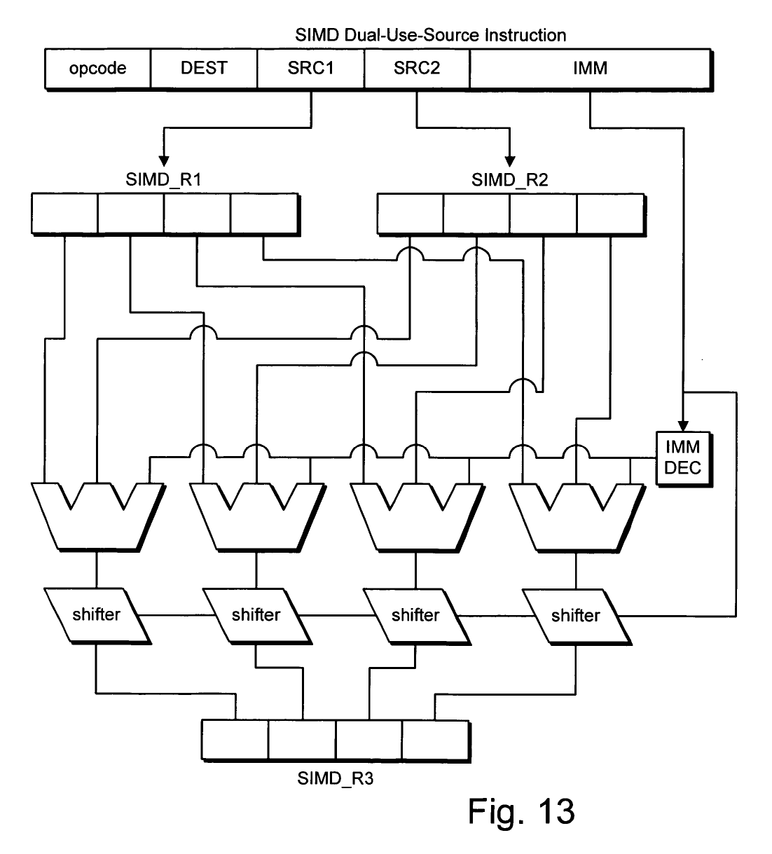

FIG. 14 illustrates another SIMD processor implementation of the dual-use-source instruction. The SIMD instruction (not shown) specifies three SIMD data sources such as registers (SIMD_R1, SIMD_R2, and SIMD_R3) and a SIMD result destination (SIMD_R4). One of the specified data sources (SIMD_R3) provides potentially unique rounding bias values to each of the ALUs' adders. Each ALU includes its own immediate decoder which, in response to that ALU's particular rounding bias value, generates a shift count for that ALU's shifter.

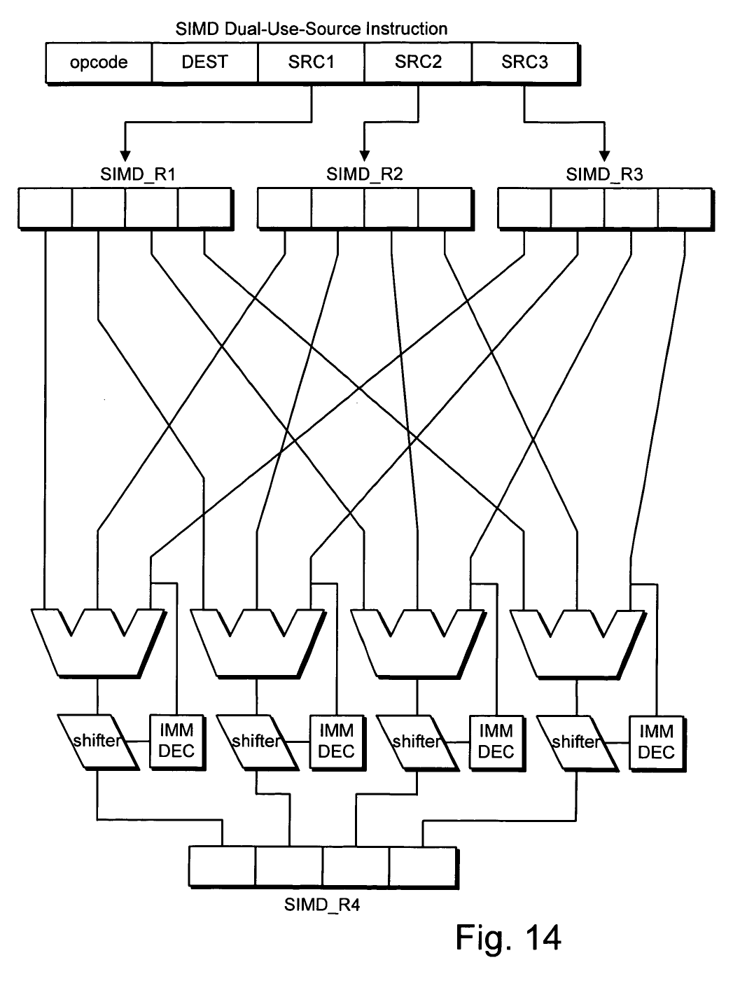

FIG. 15 illustrates one method of executing the ADDSRN instruction, and may be understood with reference to FIGS. 6 and 12 also. Execution of other instructions is not illustrated. The method begins (100) with the processor receiving (102) an instruction from a cache, from memory, or the like. The instruction decoder decodes (104) the instruction. If (106) the instruction is not an addition or subtraction instruction, the method terminates (but the instruction will be executed outside the bounds of the illustrated method). If the instruction is an addition or subtraction instruction, its first two sources SRC1 and SRC2 are passed (108) to the adder. They may come from the register file, or as immediates, or as results of previously executed instructions arriving via a bypass mux, or other such sources. The immediate decoder speculatively decodes (110) the third source SRC3.

If (112) the is_ADDSRN signal indicates that the instruction is the ADDSRN instruction, the decode mux passes (114) the decoded third source value; otherwise, it passes (116) the original third source value. The SRC3_Select signal will cause the bypass mux to pass (118) the output of the decode mux. If the is_{—}3S control signal indicates that the current instruction is a three-operand instruction, the 3S mux will pass (122) the value from the bypass mux; otherwise, it will pass (124) a zero (which is inert in addition and subtraction).

The adder then adds or subtracts (depending upon the opcode) its three operands. The adder will treat the operands as either signed or unsigned values, according to an is_Signed control signal. In one embodiment, the rounding bias (third operand) is always unsigned, regardless of whether the other operands are signed or unsigned.

If (128) the current instruction performs shifting, as indicated by the is_Shift control signal, the shift count mux passes (130) the shift count control word from the bypass mux; otherwise, it passes (132) a zero. The output of the adder is right shifted (134) by the number of bit positions indicated by the shift count mux output (with suitable handling for a zero shift, of course). The shifted result is then written (136) to the destination specified by the instruction, and the method ends (138).

Thus, the original SRC3 source value has ultimately provided two values: a shift count control value expressly specified by the SRC3 value, and a third addend value derived from the shift count according to a predetermined formula or the like. (Note that the shift count is expressly specified in the form of a control word, not as a binary value.)

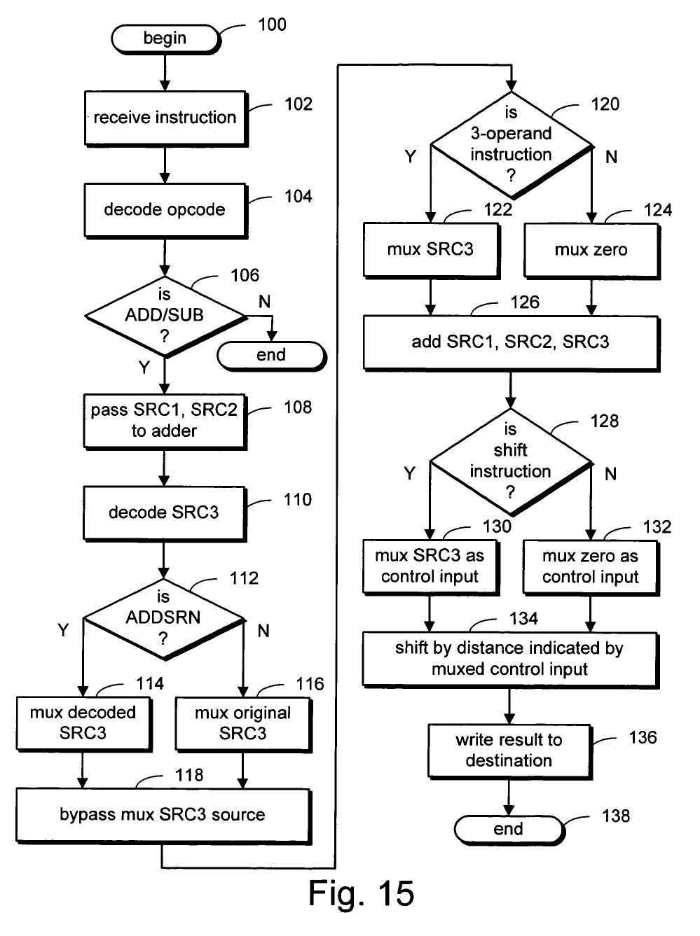

FIG. 16 illustrates a more generic method of executing an instruction, not necessarily limited to the case of an addition/subtraction instruction in which a source expressly specifies an operand value and implicitly specifies a control value. The method of FIG. 16 more broadly describes the execution of any type of instruction in which a source expressly specifies one of an operand value and a control value, and implicitly specifies the other. The reader may wish to make continued reference to FIG. 12 also.

The method begins (150) with the processor receiving (152) the instruction. The instruction decoder decodes (154) the instruction, and the processor selects (156) an execution unit suitable for executing this particular type of instruction. All SRC source values are passed (158) to the selected execution unit. If (160) the instruction is not a dual-use-source instruction, the execution unit executes (162) the instruction by performing its operation upon the input source values, and the result is written (164) to the specified destination.

However, if (160) the instruction is a dual-use type, one of the source values (SRC-X) is decoded into a decoded value DEC_SRC, which is also passed (172) to the execution unit. In some instances, the original source value SRC-X may expressly provide an operand data value, with a control value being implied thereby. In other instances, the original source value SRC-X may expressly provide a control value, with an operand data value being implied thereby. If (174) the current instruction is of the former type, in which the original source value SRC-X provides an operand data value and the decoded value DEC_SRC is a control value, the execution unit executes the operation upon all the original SRC source values including SRC-X, using the DEC_SRC value as a control input which determines some characteristic of the operation (such as shift count, signed/unsigned type, shift direction, carry mode, operand size, rounding mode, saturation mode, or any other suitably controllable execution characteristic). If (174) the current instruction is of the latter type, the execution unit executes the operation upon the DEC_SRC value and all of the original SRC values except the SRC-X value, with the SRC-X value being used as a control input determining some characteristic of the operation. In either case, the results are written (164) to the specified destination, and the method ends (168).

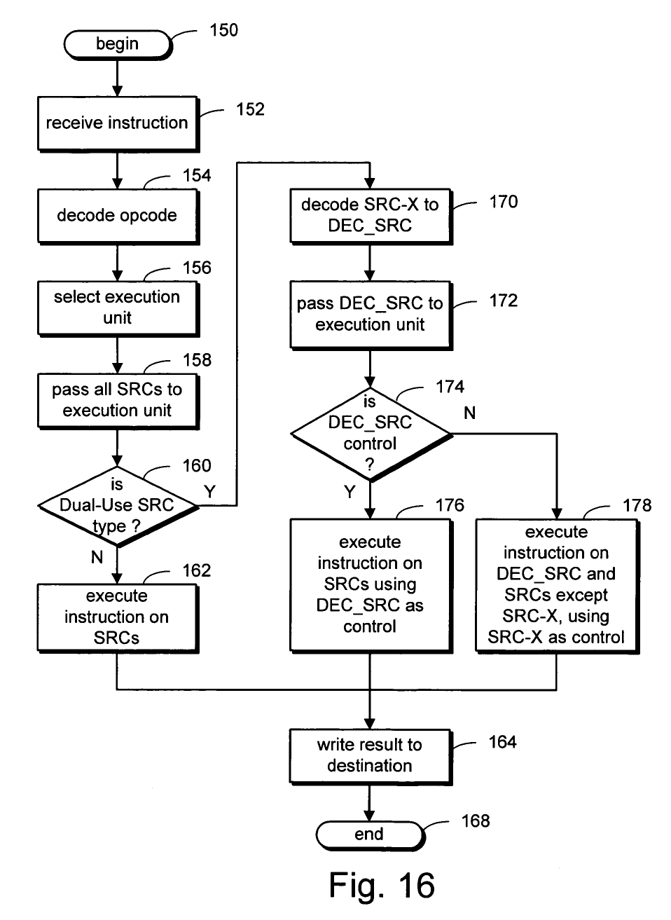

FIG. 17 illustrates another method of operating a processor to execute a dual-use-source instruction. The method begins (180) when the instruction is received (182) from cache or memory, then the instruction decoder decodes (184) the instruction's opcode to identify the instruction type. According to the instruction type, the scheduler selects (186) an appropriate execution unit.

If (190) the instruction is a dual-use-source type, an operand value and a control value are generated (194) from one of the source values. That source value does not expressly provide either the operand value nor the control value; both are derived. The instruction is executed (196) using the other source values, if any, and the derived source value, with the derived control value determining some characteristic of the functionality, such as the shift count or the like. If (190) the instruction was of another type, it would be executed (192) using all of its source values. In either case, the result is written (198) to the appropriate destination, and the method ends (200).

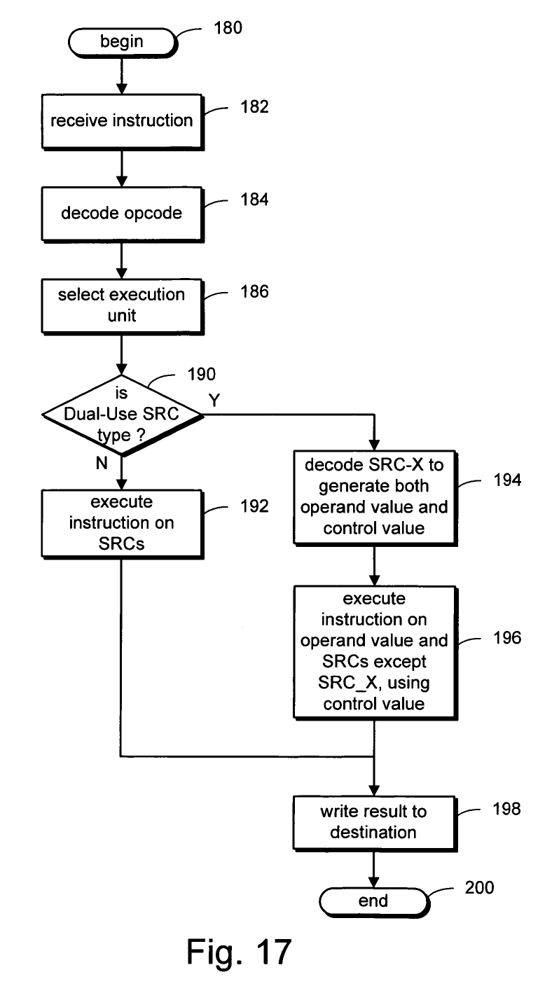

FIG. 18 illustrates one method whereby a SIMD processor executes a dual-use-source SIMD instruction. The reader may also wish to refer to FIG. 13. The method begins (210) when the processor receives (212) the dual-use-source SIMD instruction and decodes (214) it. The processor passes (216) to each SIMD ALUi its respective first SIMD operand SRC1[i] and its respective second SIMD operand SRC2[i]. The processor decodes (218) the common dual-use-source operand SRC3. In the example shown, SRC3 is a shift control word having a single bit set to 1, and the processor decodes this value into a corresponding rounding bias value, which is provided (220) in parallel to all of the SIMD ALUs.

The SIMD ALUs add (222) their respective operands, including the common rounding bias value, and pass their resulting sums to their respective shifters. The common shift control word is passed (224) to each of the shifters, which shift (226) their respective sum inputs accordingly. The shifted sums are written (228) to the respective SIMD destinations SIMD_R3[i], and the method ends (230).

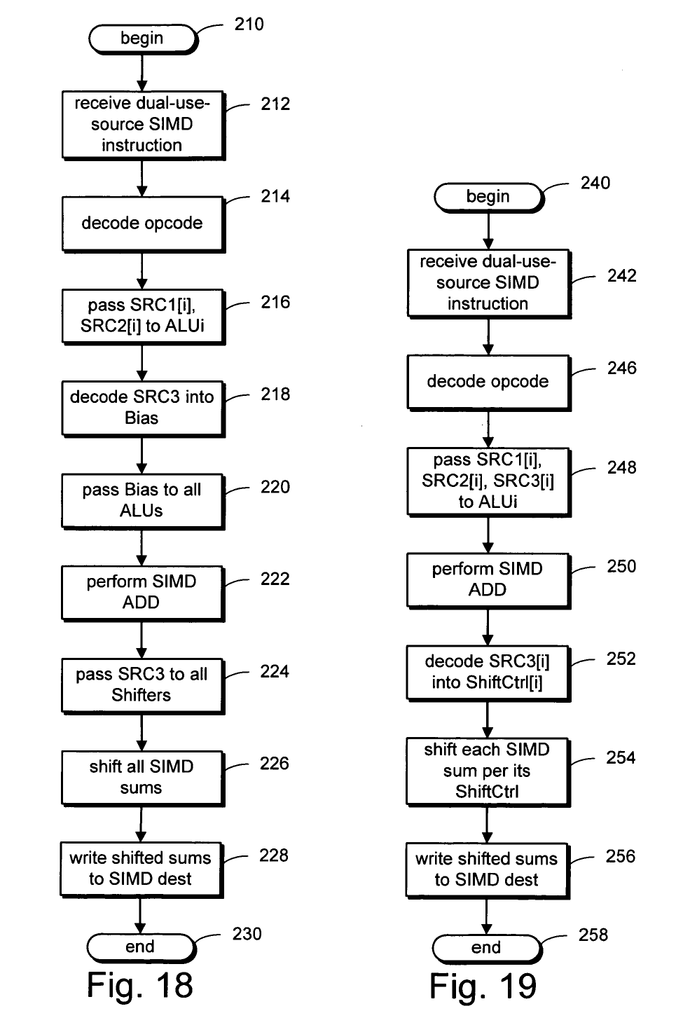

FIG. 19 illustrates another method whereby a SIMD processor executes a dual-use-source SIMD instruction. The reader may also wish to refer to FIG. 14. The method begins (240) when the processor receives (242) the dual-use-source SIMD instruction and decodes (244) it. The processor passes (246) to each SIMD ALUi its respective first SIMD operand SRC1[i], its respective second SIMD operand SRC2[i], and its respective rounding bias value SRC3[i]. In the example shown, SRC3 is a SIMD register (SIMD_R3) which contains a potentially unique rounding bias value for each of the SIMD ALUs.

The SIMD ALUs add (250) their respective operands, each using its respective rounding bias value, and pass their resulting sums to their respective shifters. Each ALU decodes (252) its SRC3[i] value into a corresponding shift control word ShiftCtr1[i], and each shifter shifts (254) its respective sum accordingly. The processor writes (256) the shifted sums to their respective SIMD destinations SIMD_R4[i], and the method ends (258).

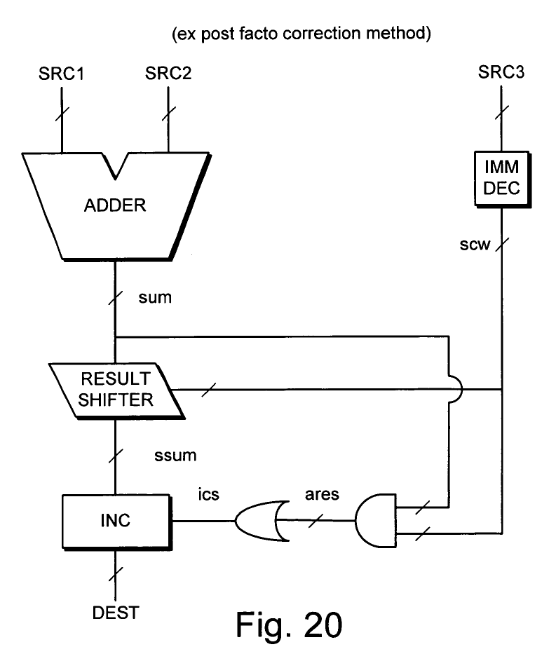

FIG. 20 illustrates an alternative mechanism for executing an ADDSRN instruction which specifies two source operands SRC1 and SRC2, as well as a dual-use source operand SRC3 which specifies a value from which are obtained both a rounding bias and a shift count. This implementation takes advantage of the relationship between a shift count of N and its corresponding rounding bias 2^{N-1}. The two source operand values are provided to a two-input adder, which generates a sum (“sum”). The dual-use source value is provided to an immediate decoder, which generates the shift control word (“scw”). A shifter shifts the adder's sum output by the number of bit positions specified by the shift control word to produce a shifted sum (“ssum”). The shift control word does not include the “shift by zero” LSB as provided by the immediate decoder—either the architecture does not allow shifting by zero, or the result shifter includes logic such as a NOR gate generating that bit from the bits of the shift control word.

The sum is AND'ed (bitwise) with the shift control word, producing an output (“ares”) of the same width as each of them. The shift control word contains a single 1 in a bit position X, and 0's in the rest of the bit positions; thus, it serves as a mask for testing the state of the sum bit in position X. If that tested bit is also a 1, it means that the rounding bias 2^{N-1} (which is never actually generated in this embodiment) should have been added in with the two operands in generating the sum.

The bits of the output of the AND unit are OR'ed together, producing a single-bit incrementer control signal (“ics”) which indicates whether the rounding bias should have been added in. The output of the shifter is provided to an incrementer which is controlled by this single-bit control signal from the OR gate. If the control signal is a 1, the incrementer increments the shifted result, otherwise it simply passes the shifted result through, producing the output result which is written to the destination specified by the instruction. In one embodiment, the incrementer can simply be an adder which adds the shifted result and the zero-extended OR gate output.

The following table illustrates the operation of this embodiment in the case where the rounding bias should have been added in; or, in other words, in which the result should have been rounded up.

| | MSB | | | | | | | LSB |
|---|---|---|---|---|---|---|---|---|
| SCW := IMMDEC(“N”); | 0 | 0 | 0 | 0 | 0 | 1 | 0 | 0 |
| decode | | | | | | | | |
| ; BIAS “2\hat{ }(N−1)” same as | 0 | 0 | 0 | 0 | 0 | 1 | 0 | 0 |
| SCW | | | | | | | | |
| SRC1 | 0 | 0 | 1 | 1 | 1 | 0 | 0 | 1 |
| SRC2 | 1 | 0 | 1 | 0 | 0 | 1 | 1 | 0 |
| SUM := SRC1 + SRC2 ; | 1 | 1 | 0 | 1 | 1 | 1 | 1 | 1 |
| ADD | | | | | | | | |
| SSUM := SUM >> SCW ; | 0 | 0 | 0 | 1 | 1 | 0 | 1 | 1 |
| SHIFT | | | | | | | | |
| ARES := SUM & SCW ; | 0 | 0 | 0 | 0 | 0 | 1 | 0 | 0 |
| MASK | | | | | | | | |
| ICS := OR(ARES) | | | | | | | | 1 |
| DEST := SSUM + ICS ; INC | 0 | 0 | 0 | 1 | 1 | 1 | 0 | 0 |

Everything from the N^{th} position right will be shifted right and discarded. If the N^{th} position of the sum is a 1, that portion is at least 0.5, and the result should be rounded up to the next integer value.

The following table illustrates the operation of this embodiment in the case where the rounding bias should not have been added in; or, in other words, in which the result should not have been rounded up.

| | MSB | | | | | | | LSB |
|---|---|---|---|---|---|---|---|---|
| SCW := IMMDEC(“N”) ; | 0 | 0 | 0 | 0 | 0 | 1 | 0 | 0 |
| decode | | | | | | | | |
| ; BIAS “2\hat{ }(N−1)” same as | 0 | 0 | 0 | 0 | 0 | 1 | 0 | 0 |
| SCW | | | | | | | | |
| SRC1 | 0 | 0 | 1 | 1 | 1 | 0 | 0 | 1 |
| SRC2 | 1 | 0 | 1 | 0 | 0 | 0 | 1 | 0 |
| SUM := SRC1 + SRC2 ; | 1 | 1 | 0 | 1 | 1 | 0 | 1 | 1 |
| ADD | | | | | | | | |
| SSUM := SUM >> SCW ; | 0 | 0 | 0 | 1 | 1 | 0 | 1 | 1 |
| SHIFT | | | | | | | | |
| ARES := SUM & SCW ; | 0 | 0 | 0 | 0 | 0 | 0 | 0 | 0 |
| MASK | | | | | | | | |
| ICS := OR(ARES) | | | | | | | | 0 |
| DEST := SSUM + ICS ; INC | 0 | 0 | 0 | 1 | 1 | 0 | 1 | 1 |

Again, everything from the N^{th} position right will be shifted right and discarded. If the N^{th} position of the sum is a 0, that portion is less than 0.5, and the result should not be rounded up.

The circuit illustrated works for the “round to nearest up” rounding mode. Various alterations may be made to this circuit, to yield the same results. For example, the OR gate could be replaced with an adder, with the LSB of the adder controlling the incrementer.

Different circuitry will be used to implement other rounding modes.

### Conclusion

When one component is shown as being adjacent to another component, it should not be interpreted to mean that there is absolutely nothing between the two components, only that they are coupled in some fashion.

The various features illustrated in the figures may be combined in many ways, and should not be interpreted as though limited to the specific embodiments in which they were explained and shown.

The term “processor” has been used in this disclosure to refer to any of a variety of data processing mechanisms. This invention may be used in, for example, a monolithic single-chip processor, a multi-chip processor module, an embedded controller, a microcontroller, or a variety of other such machines capable of executing software, whether embodied as a digital signal processor or as a general purpose microprocessor. The processor may have any of a variety of Instruction Set Architectures.

The processor may include one or more ALUs, any number of which may be capable of executing the new ADDSRN instruction. The invention is not limited to the case where the mnemonic “ADDSRN” is used to identify the instruction in assembly language.

The invention may be used in a fixed-width processor which can only handle data of a single predetermined width (such as 32 bits), or in a processor which can handle data in a variety of widths (such as 8 bits, 16 bits, or 32 bits). It may be used in a processor having a RISC architecture, a CISC architecture, a VLIW architecture, or whatever other architecture may be suitable. It may be used in a SISD (single instruction, single data) implementation, or in a SIMD (single instruction, multiple data) implementation, or in a MIMD (multiple instruction, multiple data) implementation. The invention may be practiced in integer arithmetic, fixed point arithmetic, or floating point arithmetic.

Although the invention has been described with reference to an addition instruction, it may also be used in a subtract instruction, or in a subtract reverse instruction. The term “additive instruction” may be used to generically refer to any particular species of addition or subtraction instruction. The invention may even be practiced in non-additive instructions, such as multiplication instructions, division instructions, and so forth. Addition, subtraction, multiplication, and division instructions may generically be referred to as “arithmetic” instructions. The invention may be practiced with any of a variety of rounding modes of arithmetic instructions.

While the invention has been shown in the context of a three-input adder and a three-operand instruction, it can be practiced in any other size machine. If practiced in a VLIW machine, the VLIW instruction may, in fact, be able to specify all of the source operands and the immediate shift count value, of a many-operand operation.

While the invention has been illustrated with reference to an embodiment in which the ALU extrapolates the final data operand value from an immediate which specifies the shift count, it could also be practiced in an embodiment in which the immediate specifies the final source operand immediate value and the ALU extrapolates the shift count from that imm value.

And while the invention has been explained with reference to an embodiment in which a single source provides both an operand having a first value and a shift count having a second value, in the broader sense, the invention may be practiced in embodiments in which a single source provides an operand value and some other control value. While the relationship between these has been illustrated as being N and 2^{N-1}, the invention is not limited to this relationship but can use any other relationship in which the operand value and the control value are not identical.

And while the instruction has been illustrated with reference to an embodiment in which there are one or more operands beyond the one which provides both the operand value and the control value, it may be used in single-operand instructions as well.

While the invention has been illustrated with reference to various embodiments in which the source value decoding etc. logic is part of the ALU, in other embodiments this logic could be located at various other places in the processor.

And while the invention has been described with reference to embodiments in which the processor includes a register file, it may equally be practiced in embodiments in which there is no register file, but in which the operands are taken directly from memory such as an attached or on-die SRAM memory.

The dual-use source may specify the binary value of the control value, and the processor may decode that control value into a control word value. For example, the dual-use source may have the value 011₂, which is 3₁₀, which the processor may decode into the “one-hot” shift control word value 000001000₂ which means “shift by 3” (the LSB meaning “shift by zero”).

And, finally, in some embodiments, the original bit pattern of the dual-use-source operand may be used directly as an operand value and/or a control word, while in other embodiments, the original bit pattern must be decoded to obtain the operand value and/or the control word. Typically, to save bits in the instruction, the original bit pattern is an encoded value.

In one embodiment, the following encoding is used:

| SRC3 bits | Rounding Bias bits | Shift Control Word bits |
|---|---|---|
| 000 | 00000001 | 000000010 |
| 001 | 00000010 | 000000100 |
| 010 | 00000100 | 000001000 |
| 011 | 00001000 | 000010000 |
| 100 | 00010000 | 000100000 |
| 101 | 00100000 | 001000000 |
| 110 | 01000000 | 010000000 |
| 111 | 10000000 | 100000000 |

Note that the Shift Control Word bits are shown in this table as including the “shift by zero” LSB. Per this encoding, three instruction bits provide the ability to shift by as much as 8 bit positions, corresponding to a division by 256, with corresponding rounding bias as large as 128. In other words, SRC3 provides the value N−1, where the shift is by N bits and the rounding bias is 2^{N-1}. Stated alternatively, SRC3 provides the value N, where the shift is by N+1 bits and the rounding bias is 2^{N}.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A processor for executing a plurality of instructions, each instruction including an opcode that specifies functionality of the instruction, a first instruction of the plurality further including a first source field and a dual-use source field, the processor comprising:
(a) an instruction decoder for decoding the instructions;
(b) a register file for storing data;
(c) a first additive execution unit,
(1) coupled to receive data from and store results to the register file,
(2) coupled to receive decoded instructions from the instruction decoder,
(3) for executing the first instruction by performing an additive functionality specified by an opcode of the first instruction upon a first operand value identified by the first source field and upon a second operand value,
(4) wherein functionality of the first execution unit is controlled by an opcode of the first instruction and by a control value; and (d) logic,
(1) coupled to receive the dual-use source operand,
(2) coupled to the first execution unit,
(3) for generating, in response to a value of the dual-use source operand, one of the second operand value and the control value,
(4) wherein the other of the second operand value and the control value comprises one of,
(i) the value of the dual-use source operand, and
(ii) another value generated by the logic in response to the value of the dual-use source operand.

2. The processor of claim 1 wherein:
the first instruction comprises an add-shift-round instruction and the second operand value comprises a rounding bias.

3. The processor of claim 2 wherein:
for a shift count N specified by the dual-use source field, the rounding bias is derived as 2^{N-1}.

4. The processor of claim 7 wherein:
the value of the source operand comprises the second operand value.

5. The processor of claim 4 wherein:
the first instruction comprises an add instruction and the first operand value comprises an addend.

6. The processor of claim 5 wherein:
the first instruction comprises an add-shift instruction and the control value comprises a shift count.

7. The processor of claim 6 wherein:
the first instruction comprises an add-shift-round instruction and the second operand value comprises a rounding bias.

8. The processor of claim 7 wherein:
for a rounding bias 2^{N-1}, the shift count is derived as N.

9. The processor of claim 7 wherein:
the other of the second operand value and the control value is also generated by the logic in response to the value of the dual-use source operand.

10. The processor of claim 9 wherein:
the first instruction comprises an add-shift-round instruction and for a value N of the source operand, the second operand value is generated as 2^{N} and the control value is generated as N+1.

11. The processor of claim 1 wherein:
the source operand comprises an immediate value.

12. The processor of claim 11 wherein:
the first instruction comprises an add-shift-round instruction.

13. The processor of claim 12 wherein:
the immediate value N comprises a shift control value; and
the logic generates the second operand value as a rounding bias value 2^{N-1}.

14. The processor of claim 12 wherein:
in response to the immediate value N, the logic generates a rounding bias value 2^{N} as the second operand value and a shift control value N+1 as the control value.

15. A SIMD processor adapted to execute instructions including an additive-shift-round instruction which includes an opcode field, a first SIMD source field, a second SIMD source field, and a dual-use field, the SIME processor comprising:
means for retrieving (i) a first SIME operand including a plurality of first scalar operand values in response to contents of the first SIMD source field, and (ii) a second SIMD operand including a plurality of second scalar operand values in response to contents of the second SIMD source field;
means for generating a shift control word and a rounding bias value in response to contents of the dual-use field;
a SIMD additive execution unit for performing an additive operation specified by the opcode field upon corresponding ones of (i) the first scalar operand values, (ii) the second scalar operand values, and (iii) the rounding bias value, to generate a SIMD additive result including a plurality of scalar additive result values;
a SIMD shift unit for shifting each of the scalar additive result values in response to the shift control word, to generate a SIMD shifted result including a plurality of scalar shifted result values; and
means for storing the SIMD shifted result.

16. The SIMD processor of claim 15 wherein:
the shift control word represents a shift distance N and the rounding bias value has a value 2^{N-1}.

17. The SIMD processor of claim 15 wherein:
the dual-use field comprises an immediate value field; and
the SIME additive execution unit uses a same rounding bias value in each additive operation in generating the SIMD additive result.

18. The SIMD processor of claim 15 wherein:
the dual-use field comprises a third SIMD source field; and
the SIMD additive execution unit uses, in generating each of the scalar additive result values, a respective rounding bias value identified by the third SIMD source field.

19. A processor for coupling to a memory, the processor comprising:
a register file;
an instruction fetcher coupled to receive instructions from the memory, the instructions including an add-shift-round instruction;
an instruction decoder coupled to the instruction fetcher for decoding fetched instructions;
an instruction scheduler coupled to the instruction decoder for scheduling decoded instructions for execution;
a plurality of execution units coupled to the instruction scheduler and the register file for executing the scheduled instructions and writing results of the executed instructions to the register file, wherein the plurality of execution units includes,
a dual-use-source ALU for executing the add-shift-round instruction, and including,
an adder coupled to receive source operands, for adding the source operands to generate a sum,
a shifter coupled to the adder for shifting the sum to generate a result, and
logic coupled to receive a dual-use-source operand, the dual-use-source operand specifying one of a rounding addend and a shift count, for generating the other of the rounding addend and the shift count,.
wherein the adder is coupled to receive the rounding addend from the logic, and the shifter is coupled to receive the shift count from the logic.

20. The processor of claim 19 wherein:
the dual-use-source operand specifies the shift count, and the logic generates the rounding addend.

21. The processor of claim 20 wherein:
for a value N of the shift count, the logic generates a value 2^{N-1} as the rounding addend.

22. The processor of claim 21 wherein the logic comprises:
an immediate decoder coupled to decode the dual-use-source operand into the rounding addend;
a decode mux coupled to receive the dual-use-source operand and the rounding addend, and controlled by a signal indicating whether a current instruction is the add-shift-round instruction, an output of the decode mux being coupled to an input of the adder;
a shift count mux coupled to receive an output of the decode mux and a zero value, and controlled by a signal indicating whether the current instruction is a shift instruction;
the shifter being controlled by a signal comprised at least in part by an output of the shift count mux.

23. The processor of claim 22 wherein:
the signal controlling the shifter further comprises a least significant bit which is 1 when either the current instruction is not a shift instruction or the output of the shift count mux is zero.

24. An improvement in a processor, the processor including means for retrieving source data operands and instructions, means for executing the instructions, and means for storing results of the executed instructions, wherein the improvement comprises:
the processor having an ability to execute an instruction which specifies an operation, a plurality of source data operands, and an immediate value;
wherein, the immediate value specifies one of a final source data value and a shift count; and
the processor ability includes an ability to derive the other of the final source data value and the shift count, from the immediate value.

25. The improvement of claim 24 in the processor, wherein:
the immediate specifies the shift count N; and
the processor derives the final source data value from the specified shift count.

26. The improvement of claim 25 in the processor, wherein:
the processor derives the final source data value as 2^{N-1}.

27. The improvement of claim 24 in the processor, wherein:
the immediate specifies a value N from which the processor derives the final source data value 2^{N} and the shift count N+1.

28. The improvement of claim 24 in the processor, wherein:
the operation comprises an addition.

29. The improvement of claim 24 in the processor, wherein:
the operation comprises a subtraction.

30. The improvement of claim 24 in the processor, wherein:
the operation comprises a subtraction in reverse order.

31. The improvement of claim 24 in the processor, wherein:
the shift comprises a right shift.

32. A method of processing data in a processor, comprising in the execution of a single instruction:
receiving M source data values from sources specified by operands of the instruction;
receiving an immediate value specified by an operand of the instruction;
deriving one of a rounding bias value and a shift count from the immediate value, the immediate value specifying the other of the rounding bias value and the shift count;
performing an arithmetic operation on the source data values and the rounding bias value to generate a result value; and
shifting the result value by the shift count to generate a shifted result value.

33. The method of claim 32 wherein:
the arithmetic operation comprises addition.

34. The method of claim 32 wherein:
the arithmetic operation comprises subtraction.

35. The method of claim 32 wherein:
the immediate specifies the shift count N.

36. The method of claim 35 wherein:
the rounding bias comprises 2^{N-1}.

37. The method of claim 32 wherein the immediate specifies a value N, the method further comprising:
the processor deriving the final source data value 2^{N} and the shift count N+1 from the immediate value N.

38. A digital signal processor adapted for executing instructions of an ISA, the ISA including an arithmetic-shift-round instruction specifying a plurality of source operands and an arithmetic operation to be performed upon those operands, wherein one of the source operands directly specifies one of a rounding operand and a shift count, the digital signal processor adapted to generate the other of the rounding bias operand and the shift count implicitly from the one of them which is directly specified by the arithmetic-shift-round instruction.

39. The digital signal processor of claim 38 wherein the one of the source operands directly specifies the shift count N, and the digital signal processor is adapted to generate the rounding bias operand as 2^{N-1}.

40. The digital signal processor of claim 38 wherein the shift count is specified in an encoded format by the one of the source operands, and the digital signal processor is adapted to generate the rounding bias operand and a shift control word by decoding the shift count.

41. The digital signal processor of claim 40 wherein the rounding bias operand and a non-zero-shift portion of the shift control word have a same bit value pattern.

42. The digital signal processor of claim 38 wherein the arithmetic-shift-round instruction is an add-shift-round instruction.
